(19) United States
(12) Patent Application Publication
(10) Pub. No.: US 2004/0192877 A1
(43) Pub. Date: Sep. 30, 2004

(54) Property enhancement of polyamides by co-condensation with lightstabilizers

(76) Inventors: Christoph Krohnke, Breisach (DE); Jan Malik, St. Louis (FR)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/485,896

(22) PCT Filed: Aug. 5, 2002
(86) PCT No.: PCT/IB02/03068

(30) Foreign Application Priority Data
Aug. 6, 2001 (GB) 0119137.8

(51) Int. Cl. C08G 2/00

(52) U.S. Cl. 528/220

(57) ABSTRACT

The instant invention relates to polyamides containing chemically bound UV-absorbers of the type oxanilide or benzylidene-malonate produced by co-condensation of the UV-absorbers with the prepolymeric compounds and to a process for the production of polyamides with improved mechanical properties wherein the prepolymeric compounds and the UV-absorbers are mixed prior to the condensation reaction and wherein the UV-absorbers are used in a concentration range of from 0.0001 to 5% by weight, related to the prepolymeric compounds.

The instant polyamides are especially suitable for the manufacture of fibres having improved mechanical properties.

The instant invention relates to polyamides containing chemically bound UV-absorbers produced by co-condensation of the UV-absorbers with the prepolymeric compounds.

According to chemical composition the majority of polyamides may be classified as wholly aromatic, aromatic-aliphatic, wholly aliphatic or alicyclic-aliphatic. The largest volume polyamides, nylon 6 and nylon 66, are aliphatic polyamides. In the terminology of the U.S. Federal Trade Commission, “nylons” are fibers made by polycondensation from aliphatic and alicyclic polyamides, and aramids are fibers made from aromatic polyamides having at least 85% of the amide linkages directly attached to two aromatic rings. In the terms of use, nylon and aramid refer not only to the fiber but also to the polyamide itself.

The high melting point of aramids, an asset in fiber applications, makes their fabrication by molding impractical. Most nylons can be used as plastics in addition to being used as fibers; some, such as nylon 12, are only used as plastics. Additionally some polyamides are used as adhesives and coatings.

Products with lower melting points and broader melt processing ranges are achieved by copolymerization of standard polyamide monomers with other aliphatic monomers. In general those copolymers show reduced levels of crystallinity, density and stiffness but improved solubility.

Polyamides are processed into final articles by a variety of different techniques such as injection molding, blow molding, extrusion, casting, solution coating and electrostatic coating. In order to meet the required conditions for the required process the molecular mass can be altered. Their range of final applications is fairly broad reaching for example from transportation purposes to non-reinforced resins for electrical connectors and windshields to (glass-)reinforced polyamides for automotive applications and mineral filled polyamides mainly for the automotive sector as well.

All these applications require special properties, which can be maintained, supported by the use of appropriate additives. In particular good impact strength, hardness, very good abrasion resistance, and dimensional stability upon heating, resistance to organic solvents and good lubricity characteristics are required.

Especially for the protection of polyamide-fibers—for example as used for carpets—and for maintaining of their spinning efficiencies certain additives are incorporated during the production process. Stabilizers guarantee enhanced thermal stability, tenacity and fatigue resistance but also better color characteristics during long-term thermal and light exposure. A homogeneous distribution of those additives in the polymer matrix is an important prerequisite for an economical spinning process as well as for long-living high quality fibers.

However, the industry has to face problems arising from the exposure of the polyamide article (e.g. PA-fiber) to daylight for an extended lifetime. Macroscopically observable degradation effects range from color fading via surface decomposition to complete degradation of the PA-article with subsequent abrasion of the damaged pile segments.

Degradation of synthetic polyamides can be induced by sunlight, heat, oxygen, and many kinds of impurities resulting in a bond scission of the polyamide-chain. Due to their large surface-to-volume ratio especially polyamide-fibers are susceptible to degradation by processes such as photo-oxidation by radical processes.

The most obvious possibility to protect polymers against degradation by UV-light bases on the prevention or at least reduction of UV-light absorption using molecules with appropriate chromophores. Those compounds are transformed into an excited state which is deactivated by rapid intramolecular processes returning finally to its original ground state [H. Zweifel, Stabilization of Polymeric Materials, Springer Publishers, Berlin, Heidelberg, New York, pp.59 (1998)]. Another possibility is given by reduction of the initiation rate through deactivation of light-induced excited states.

Therefore, UV-absorbers are able to absorb harmful radiation and dissipate them in general as heat. Those molecules must be photochemically very stable because otherwise they would be consumed too fast in secondary reactions [Lit. R. Gächter and H. Müller, Plastics Additives Handbook, 3^{rd} ed., Hanser Publishers, Munich, Vienna, New York, pp.175 (1990)]. UV-absorbers are generally colorless compounds characterized by high extinction coefficients in the spectral range of λ=280-400 nm. Conventionally these compounds are dissolved in the polymer matrix and compete with substrate specific absorption processes. The efficiency of an UV-absorbing reagent depends on its concentration and the thickness of the polymer article.

UV-absorbers such as those out of the class of oxanilides like 2-ethyl-2′-ethoxy-oxanilide (commercially available as ®Sanduvor VSU),

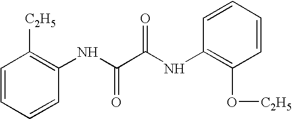

of benzylidene-malonates like propanedioic acid-[(4-methoxyphenyl)-methylene]-dimethylester (commercially available as ®Sanduvor PR-25)

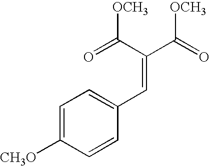

and structurally related benzylidene-bis-malonates are used as colorless UV-absorbers for plastics in the short wavelength regime (high energy UV-B).

Despite their efficiency polyamides conventionally mixed with those kinds of stabilizers suffer often in a long time range from migration and evaporation at different extent out of the substrate.

Surprisingly it has now been found that a co-condensation of the above mentioned UV-absorbers with polyamide leads to a stabilized polyamide material which can be produced into fibres with improved mechanical properties.

At the beginning attempts to co-condensate UV-absorbers of the given type during manufacture of the corresponding polyamide appeared a risky undertaking since it was absolutely unclear whether chemical reaction by “tailor-made” co-condensation would take place, which kind of copolymers be built up (copolymers with statistically distributed comonomers or blockcopolymers), whether the basic structure of the basic UV-absorber would change in the sense that the molecule or later on the monomer unit would loose their efficiency and which consequences on final properties of the final product would have been achieved.

The resulting polyamide fibres unexpectedly showed improved mechanical properties compared to conventional methods of adding the stabilizers to the already polymerized polymer.

Object of the invention is therefore a polyamide containing chemically bound UV-absorbers of the type oxanilide or benzylidene-malonate produced by co-condensation of the UV-absorbers with the prepolymeric compounds.

Preferred is a polyamide wherein the UV-absorbers are 2-ethyl-2′-ethoxy-oxanilide or propanedioic acid-[(4-methoxyphenyl)-methylene]-dimethylester.

Especially preferred is a polyamide as described above wherein the prepolymeric compounds are caprolactame, ε-amino-capronic acid and benzoic acid.

A further object of the invention is a process for the production of polyamides with improved mechanical properties as described above wherein the prepolymeric compounds and the UV-absorbers are mixed prior to the condensation reaction and wherein the UV-absorbers are used in a concentration range of from 0.0001 to 5% by weight, preferably from 0.001 to 3% by weight, related to the prepolymeric compounds.

A further object of the instant invention is a method of use of polyamides as described above for the manufacture of fibres having improved mechanical properties. Said UV-absorbers contain ester or amide functions able to be used “in situ” for further reactions by co-condensation during manufacture of polyamide, polyacrylamides and copolyamides basically deriving from diamines and dicarboxylic acids and/or from aminocarboxylic acids and/or the corresponding lactames.

Examples are polyamide-4, polyamide-6, polyamide-6,6, 6,9, 6,10, 6,12, 4,6, 12,12, polyamide 12, aromatic polyamides deriving from 3-xylene, diamine and adipic acid, polyamides deriving from hexamethylenediamine and iso-and/or terephthalic acid which can contain an elastomer as modifying compound such as compounds like poly-2,4,4-trimethylhexamethyleneterephthalamide or poly-3-phenylene-isophthalamide.

Further examples are block-copolymers of the mentioned polyamides with olefins, olefin-copolymers, ionomers or chemically bound/grafted elastomers or with polyethers like oligo- and/or polyethyleneglycol, polypropyleneglycol or polytetramethyleneglycol. Other polymers suitable for the instant invention are EPDM- or ABS-modified polyamides or copolyamides or special polyamides which are condensed during processing (so called “RIM-polyamide-systems”).

Also blends of the above mentioned polyamides like polyphenyleneoxide (PPO) with polyamide-6,6 and its copolymers, polyamide/polyethylene-HD, polyamide/poly-propylene and polyamide/PPO in general can be used according to the invention.

These modified substrates can be preferentially used together with other types of stabilizers such as sterically hindered phenols, sterically hindered or generally secondary or tertiary amines, organophosphites and -phosphonites and/or copper-salts e.g. Cu(II)acetylacetonate and/or thiol-compounds.

Examples of suitable additives which can additionally be employed in combination are compounds as set out below

1. Antioxidants

1.1 Alkylated monophenols, for example 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methyl-cyclohexyl)4,6-dimethylphenol, 2,6-dioctadecyl-4-methylphenol, 2,4,6-tricyclo-hexylphenol, 2,6-di-tert-butyl-4-methoxymethylphenol, linear or sidechain-branched nonylphenols, such as 2,6-di-nonyl-4-methylphenol, 2,4-dimethyl-6-(1-methylundec-1′-yl)-phenol, 2,4-dimethyl-6-(1′-methylheptadec-1′-yl)-phenol, 2,4-dimethyl-6-(1′-methyltridec-1′-yl)phenol and mixtures thereof.

1.2 Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3 Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4 Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis-(2,6-dimethyl-4-hydroxyphenyl) disulfide.

1.5 Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidene-bis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, bis(3-tert-butyl-4-hydroxy-5-methylphenyl)-dicyclo-pentadiene, bis[2-(3′-tert-butyl-2′-7hydroxy-5′-methylbenzyl)-6-tert-butyl-4-methyl-phenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methyl-phenyl)-4-n-dodecylmercaptobutane, 1,1,5,5-tetra-(5-tert-butyl-4-hydroxy-2-methylphenyl)pentane, ethylene glycol bis[3,3-bis(3′-tert-butyl-4′-hydroxyphenyl)butyrate].

1.6 O-, N- and S-benzyl compounds, for example 3,5,3′,5′-tetra-tert-butyl-4,4′-di-hydroxydibenzyl ether, octadecyl 4-hydroxy-3,5-dimethylbenzylmercaptoacetate, tris(3,5-di-tert-butyl-4-hydroxybenzyl)amine, bis(4-tert-butyl-3-hydroxy-2,6-di-methylbenzyl) dithioterephthalate, bis(3,5-di-tert-butyl-4-hydroxybenzyl) sulfide, isooctyl 3,5-di-tert-butyl-4-hydroxybenzylmercaptoacetate, tridecyl 4-hydroxy-3,5-di-tert-butylbenzylmercaptoacetate.

1.7 Hydroxybenzylated malonates, for example dioctadecyl 2,2-bis(3,5-di-tert-butyl-2-hydroxybenzyl)malonate, dioctadecyl 2-(3-tert-butyl-4-hydroxy-5-methylbenzyl)-malonate, didodecyl-mercaptoethyl-2,2-bis(3,5-di-tert-butyl-4-hydroxybenzyl)-malonate, di-[4-(1,1,3,3-tetramethylbutyl)phenyl]-2,2-bis(3,5-di-tert-butyl-4-hydroxybenzyl)malonate.

1.8 Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxy-benzyl)-2,3,5,6-tetramethylbenzene, 2,4,6-tris(3,5-di-tert-butyl-4-hydroxy-benzyl)phenol.

1.9 Triazine compounds, for example 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurat, 2,4,6-tris(3,5-di-tert-butyl-4-hydroxyphenylethyl)-1,3,5-triazine, 1,3,5-tris(3,5-di-tert-butyl-4-hydroxy-phenylpropionyl)hexahydro-1,3,5-triazine, 1,3,5-tris(3,5-dicyclohexyl-4-hydroxy-benzyl) isocyanurate.

1.10 Benzylphosphonates, for example dimethyl 2,5-di-tert-butyl-4-hydroxybenzyl-phosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the Ca-salt of the monoethyl ester of 3,5-di-tert-butyl-4-hydroxybenzylphosphonic acid.

1.11 Acylaminophenols, for example 4-hydroxylauranilide, 4-hydroxystearanilide, octyl N-(3,5-di-tert-butyl-4-hydroxyphenyl)carbamate.

1.12 Esters of β-(3,5-di-tert-butyl-4-hydroxyphenyl)propionic acid with mono- or poly-hydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thia-undecanol, 3-thia-pentadecanol, trimethylhexanediol, trimethylolpropane, 4-hydroxymethyl-1-phospha-2,6,7-trioxabicyclo[2. 2. 2]octane.

1.13 Esters of β-(5-tert-butyl-4-hydroxy-3-methylphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thia-undecanol, 3-thiapentadecanol, trimethylhexanediol, trimethylolpropane, 4-hydroxymethyl-1-phospha-2,6,7-trioxabicyclo[2.2. 2]octane.

1.14 Esters of β-(3,5-dicyclohexyl-4-hydroxyphenyl)propionic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thia-undecanol, 3-thia-pentadecanol, trimethylhexanediol, trimethylolpropane, 4-hydroxymethyl-1-phospha-2,6,7-trioxabicyclo[2.2. 2]octane.

1.15 Esters of 3,5-di-tert-butyl-4-hydroxyphenylacetic acid with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl) isocyanurate, N,N′-bis-(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16 Esters of 3,3-bis(3′tert-butyl-4′-hydroxyphenyl)butyric acid with mono- or poly-hydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)oxalamide, 3-thia-undecanol, 3-thiapentadecanol, trimethylhexanediol, trimethylolpropane, 4-hydroxy-methyl-1-phospha-2,6,7-trioxabicyclo[2.2.2]octane.

1.17 Amides of β-(3,5-di-tert-butyl-4-hydroxyphenyl)propionic acid, e.g. N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

1.18 Tocopherol, such as α-tocopherol, β-tocopherol, γ-tocopherol, δ-tocopherol and mixtures thereof (vitamin E).

1.19 Ascorbic acid (vitamin C).

1.20 Amine antioxidants, for example N,N′-diisopropyl-p-phenylenediamine, N,N′di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-di(naphthyl-2-)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(-toluenesulfonamido)diphenylamine, N,N′-di-methyl-N,N′-di-sec-butyl-p-phenylenediamine, diphenylamine, N-allyldiphenyiamine, 4-isopropoxydiphenylamine, N-phenyl-1-naphthylamine, N-(4-tert-octylphenyl)-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylaminophenol, 4-dodecanoylaminophenol, 4-octa-decanoylaminophenol, di(4-methoxyphenyl)amine, 2,6-di-tert-butyl-4-dimethylaminomethylphenol, 2,4′-diaminodiphenylmethane, 4,4′-diaminodiphenylmethane, N,N, N′,N′-tetramethyl-4,4′-diaminodiphenylmethane, 1,2-di-[(2-methylphenyl)amino]ethane, 1,2-di-(phenylamino)propane, (o-tolyl)biguanide, di[4-(1′,3′-dimethylbutyl)-phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyidiphenylamines, mixture of mono- and dialkylated isopropyl/isohexyl-diphenylamines, mixture of mono- and dialkylated tert-butyldiphenylamines, 2,3-dihydro-3,3-dimethyl-4H-1,4-benzothiazine, phenothiazine, mixture of mono- and dialkylated tert-butyl/tert-octyl-phenothiazines, mixture of mono- and dialkylated tert-octylphenothiazines, N-allylphenothiazine, N,N, N′,N′-tetraphenyl-1,4-diamino-but-2-ene, N,N-bis(2,2,6,6-tetramethylpiperidine-4-yl)hexamethylenediamine, bis-(2,2,6,6-tetramethylpiperidine-4-yl) sebacate, 2,2 ,6,6-tetramethylpiperidin-4-one, 2,2,6,6-tetramethylpiperidine-4-ol.

2. UV Absorbers and Light Stabilizers

2.1 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)-phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy4′-octoxyphenyl)-benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, a mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the transesterification product of 2-[3′-tert-butyl-5′-(2-methoxycarbonylethyl)-2′-hydroxyphenyl]benzotriazole with polyethylene glycol 300; [R—CH₂CH₂—COO—(CH₂)₃]₂ where R=3′-tert-butyl-4′-hydroxy-5′-2H-benzotriazol-2-yl-phenyl.

2.2 2-Hydroxybenzophenones, for example the 4-hydroxy, 4-methoxy, 4-octoxy, 4-decyloxy, 4-dodecyloxy, 4-benzyloxy, 4,2′,4′-trihydroxy and 2′-hydroxy-4,4′-di-methoxy derivative.

2.3 Esters of substituted or unsubstituted benzoic acids, for example 4-tert-butyl-phenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4 Acrylates, for example ethyl α-cyano-β,β-diphenylacrylate or isooctyl α-cyano-β,β-diphenylacrylate, methyl α-carbomethoxycinnamate, methyl α-cyano-β-methyl-p-methoxycinnamate or butyl α-cyano-β-methyl-p-methoxycinnamate, methyl α-carbomethoxy-p-methoxycinnamate and N-(β-carbomethoxy-β-cyano-vinyl)-2-methylindoline.

2.5 Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of monoalkyl esters, such as of the methyl or ethyl ester, of 4-hydroxy-3,5-di-tert-butylbenzyl-phosphonic acid, nickel complexes of ketoximes, e.g. of 2-hydroxy-4-methylphenyl undecyl ketoxime, nickel complexes of 1-phenyl-4-lauroyl-5-hydroxypyrazole, with or without additional ligands.

2.6 Sterically hindered amines, for example bis(2,2,6,6-tetramethylpiperidine4-yl) sebacate, bis(2,2,6,6-tetramethylpiperidine-4-yl) glutarate, bis(2,2,6,6-tetramethylpiperidine-4-yl) succinate, bis(1,2,2,6,6-pentamethylpiperidine4-yl) sebacate, bis(1,2,2,6,6-pentamethylpiperidine-4-yl) glutarate, 2,2,6,6-tetramethylpiperidyl behenate, 1,2,2,6,6-pentamethylpiperidyl-behenate, the condensate of 1-hydroxyethyl-2,2,6,6-tetramethyl-4-hydroxypiperidine and succinic acid, the condensate of N,N′-bis-(2,2,6,6-tetramethyl-4-piperidyl)-hexamethylendiamine and 4-tert-octylamino-2,6-dichloro-1,3,5-s-triazine, tris-(2,2,6,6-tetramethyl-4-piperidyl) nitrilo-triacetate, tetrakis(2,2,6,6-tetramethyl-4-piperidyl) 1,2,3,4-butantetraoate, 1,1′-(1,2-ethanediyl)-bis-(3,3,5,5-tetramethylpiperazinone), 4-benzoyl-2,2,6,6-tetramethylpiperidine, 4-stearyloxy-2,2,6,6-tetramethylpiperidine, 4-stearoyloxy-2,2,6,6-tetramethylpiperidine, 4-stearyloxy-1,2,2,6,6-pentamethylpiperidine, 4-stearoyloxy-1,2,2,6,6-pentamethylpiperidine, bis(1,2,2,6,6-pentamethylpiperidyl) 2-n-butyl-2-(2-hydroxy-3,5-di-tert-butylbenzyl )-malonate, bis(1,2,2,6,6-pentamethylpiperidyl) 2-n-butyl-2-(4-hydroxy-3,5-di-tert-butylbenzyl)malonate, 3-n-octyl-7,7,9,9-tetramethyl-1,3,8-triazaspiro[4.5] decane-2,4-dione, bis(1-octyloxy-2,2,6,6-tetramethylpiperidyl) sebacate, bis-(1-octyloxy-2,2,6,6-tetramethylpiperidyl) succinate, the condensate of N,N′-bis(2,2,6,6-tetramethyl-4-piperidyl)hexamethylenediamine and 4-morpholino-2 ,6-dichloro-1,3,5-triazine, the condensate of N,N′-bis(2,2,6,6-tetramethyl-4-piperidyl)hexamethylenediamine and 4-cyclohexylamino-2,6-dichloro-1,3,5-triazine, the condensate of 2-chloro4,6-di-(4-n-butylamino-2,2,6,6-tetramethylpiperidyl)-1,3,5-triazine and 1,2-bis-(3-aminopropylamino)ethane, the condensate of 2-chloro-4,6-di-(4-methoxypropylamino-2,2,6,6-tetramethylpiperidyl)-1,3,5-triazine and 1,2-bis-(3-aminopropylamino)ethane, the condensate of 2-chloro-4,6-di-(4-methoxypropyl-amino-1,2,2,6,6-pentamethylpiperidyl)-1,3,5-triazine and 1,2-bis-(3-aminopropyl-amino)ethane, the condensate of 2-chloro4,6-di-(4-n-butylamino-1,2,2,6,6-pentamethylpiperidyl)-1,3,5-triazine and 1,2-bis-(3-aminopropylamino)-ethane, reaction products of 2-chloro-4,6-di-(4-n-butylamino-2,2,6,6-tetramethylpiperidyl)-1,3,5-triazine with mono- or polyfunctional amines, where between one and all the active hydrogen atoms on the amine are replaced, such as with ethylenediamine, diethylenetriamine, triethylenetetramine, hexamethylenediamine, 1,2-bis-(3-aminopropylamino)ethane, reaction products of 2-chloro-4,6-di-(4-n-butylamino-1,2,2,6,6-pentamethylpiperidyl)-1,3,5-triazine with mono- or polyfunctional amines, where between one and all the active hydrogen atoms on the amine are replaced, such as with ethylenediamine, diethylenetriamine, triethylenetetramine, hexamethylenediamine, 1,2-bis(3-aminopropylamino)ethane, reaction products of 2-chloro-4,6-di-(4-n-butylamino-2,2,6,6-tetramethylpiperidyl)-1,3,5-triazine and 4-tert-octylamino-2,6-dichloro-1,3,5-s-triazine with mono- or polyfunctional amines, where between one and all the active hydrogen atoms on the amine are replaced, such as with ethylenediamine, diethylenetriamine, triethylenetetramine, hexamethylenediamine, 1,2-bis(3-aminopropylamino)ethane, reaction products of 2-chloro-4,6-di-(4-n-butylamino-1,2,2,6,6-pentamethylpiperidyl)-1,3,5-triazine and 4-tert-octylamino-2,6-dichloro-1,3,5-s-triazine with mono- or polyfunctional amines, where between one and all the active hydrogen atoms on the amine are replaced, such as with ethylenediamine, diethylenetriamine, triethylenetetramine, hexamethylenediamine, 1,2-bis-(3-aminopropyl-amino)ethane, reaction products of 2-chloro-4,6-di-(4-n-butylamino-2,2,6,6-tetramethylpiperidyl)-1,3,5-triazine and 4-(4-n-butylamino-2,2,6,6-tetramethylpiperidyl)-2,6-dichloro-1,3,5-s-triazine with mono- or polyfunctional amines, where between one and all the active hydrogen atoms on the amine are replaced, such as with ethylenediamine, diethylenetriamine, triethylenetetramine, hexamethylenediamine, 1,2-bis-(3-aminopropylamino)ethane, reaction products of 2-chloro-4,6-di-(4-n-butylamino-1,2,2,6,6-pentamethylpiperidyl)-1,3,5-triazine and 4-(4-n-butylamino-2,2,6,6-tetramethyl-piperidyl)-2,6-dichloro-1,3,5-s-triazine with mono- or polyfunctional amines, where between one and all the active hydrogen atoms on the amine are replaced, such as with ethylenediamine, diethylenetriamine, triethylenetetramine, hexamethylenediamine, 1,2-bis-(3-aminopropylamino)ethane, the condensate of 1,2-bis(3-aminopropylamino)ethane and 2,4,6-trichloro-1,3,5-triazine and also 4-butyl-amino-2,2,6,6-tetramethylpiperidine, N-(2,2,6,6-tetramethyl-4-piperidyl)-n-dode-cylsuccinimide, N-(1,2,2,6,6-pentamethyl-4-piperidyl)-n-dodecylsuccinimide, 8-acetyl-3-dodecyl-7,7,9,9-tetramethyl-1,3,8-triazaspiro[4.5]decane-2,4-dione, oligomerized 2,2,4,4-tetramethyl-20-(oxiranylmethyl)-7-oxa-3,20-diaza-dispiro-[5.1.11 .2]heneicosan-21-one, oligomerized 1,2,2,4,4-pentamethyl-20-(oxiranylmethyl)-7-oxa-3,20-diazadispiro[5.1.11.2]heneicosan-21-one, oligomerized 1-acetyl-2,2,4,4-tetramethyl-20-(oxiranylmethyl)-7-oxa-3,20-diaza-dispiro-[5.1.11.2]heneicosan-21-one, 3-dodecyl-1-(2,2,6,6-tetramethyl-4-piperidyl)-pyrrolidine-2,5-dione, 3-dodecyl-1-(1,2,2,6,6-pentamethyl-4-piperidyl)pyrrolidine-2,5-dione, 2,2,4,4-tetramethyl-7-oxa-3,20-diazadispiro-[5.1.11.2]heneicosan-21-one, 2,2,4,4-tetramethyl-7-oxa-21-oxo-3,20-diazadispiro-[5.1.11.2]heneicosane-3-propanoic acid dodecyl ester, 2,2,4,4-tetramethyl-7-oxa-21-oxo-3,20-diazadispiro-[5.1.11.2]heneicosane-3-propanoic acid tetradecyl ester, 2,2,3,4,4-penta-methyl-7-oxa-3,20-diazadispiro-[5.1.11.2]heneicosan-21-one, 2,2,3,4,4-pentamethyl-7-oxa-21-oxo-3,20-diazadispiro-[5.1.11.2]heneicosane-3-propanoic acid dodecyl ester, 2,2,3,4,4-pentamethyl-7-oxa-21-oxo-3,20-diazadispiro-[5.1.11.21-heneicosane-3-propanoic acid tetradecyl ester, 3-acetyl-2,2,4,4-tetramethyl-7-oxa-3,20-diazadispiro-[5.1.11.2]heneicosane-21-one, 3-acetyl-2,2,4,4-tetramethyl-7-oxa-21-oxo-3,20-diaza-dispiro-[5.1.11.2]heneicosane-3-propanoic acid dodecyl ester, 3-acetyl-2,2,4,4-tetramethyl-7-oxa-21-oxo-3,20-diazadispiro-[5.1.11.2]heneicosane-3-propanoic acid tetradecyl ester, 1,1′,3,3′,5,5′-hexahydro-2,2′,4,4′,6,6′-hexaaza-2,2′,6,6′-bismethano-7,8-dioxo-4,4′-bis(1,2,2,6,6-pentamethyl-4-piperidyl)biphenyl, poly-N,N′-bis-(2,2,6,6-tetramethyl-4-piperidyl)-1,8-diazadecylene, adduct of 2,2,6,6-tetramethyl-4-allyloxypiperidine and polymethylhydridosiloxane (molar mass up to 4000), adduct of 1,2,2,6,6-pentamethyl-4-allyloxypiperidine and polymethylhydridosiloxane (molar mass up to 4000), N,N′-diformyl-N,N′-bis(2,2,6,6-tetramethyl-4-piperidinyl)-hexamethylenediamine, N,N′-diformyl-N,N′-bis(1,2,2,6,6-pentamethyl-4-piperidinyl)hexamethytenediamine, 5,11-bis-(2,2,6,6-tetramethyl-4-piperidinyl)-3,5,7,9,11,13-hexaazatetra-cyclo[7.4.0.0^{2.7}.1^{3.13}]tetradecane-8,14-dione, 5,11-bis(1,2,2,6,6-pentamethyl-4-piperidinyl)-3,5,7,9,11,13-hexaazatetra-cyclo[7.4.0.0^{2.7}.1^{3.13}]tetradecane-8,14-dione, [(4-methoxyphenyl)methylene]-propanedioic acid bis(2,2,6,6-tetramethyl-4-piperidinyl) ester, [(4-methoxyphenyl)-methylene]propanedioic acid bis-(1,2,2,6,6-pentamethyl-4-piperidinyl) ester, 2,4,6-tris(N-cyclohexyl-N-[2-(3,3,4,5,5-pentamethylpiperazinon-1-yl)ethyl]amino)-1,3,5-triazine, copolymer of styrene with methylstyrene and maleic anhydride reacted with 4-amino-2,2,6,6-tetramethylpiperidine and octadecylamine, copolymer of styrene with α-methylstyrene and maleic anhydride reacted with 4-amino-1,2,2,6,6-pentamethylpiperidine and octadecylamine, polycarbonate with 2,2′-[(2,2,6,6-tetramethyl-4-piperidinyl)imino]bis-[ethanol] as diol component, polycarbonate comprising 2,2′-(1,2,2,6,6-pentamethyl-4-piperidinyl)imino]bis[ethanol] as diol component, copolymer of maleic anhydride and an α-olefin up to C₃₀ reacted with 4-amino-2,2,6,6-tetramethylpiperidine, copolymer of maleic anhydride and an α-olefin up to C₃₀ reacted with 1-acetyl-4-amino-2,2,6,6-tetramethylpiperidine, copolymer of maleic anhydride and an α-olefin up to C₃₀ reacted with 4-amino-1,2,2,6,6-pentamethylpiperidine, and also the N-alkyl- and N-aryl-oxy derivatives of the abovementioned compounds with free NH groups on the piperidine, especially α-methylbenzyloxy and alkyloxy from C₁ to C₁₈.

2.7 Oxalamides, for example 4,4′-dioctyloxyoxanilide, 2,2′-diethoxyanilide, 2,2′-di-octyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)-oxalamide, 2-ethoxy-5-tert-butyl-2′-ethyloxanilide and its mixture with 2-ethoxy-2′-ethyl-5,4′-di-tert-butyl-oxanilide and mixtures of o- and p-methoxy-disubstituted and of o- and p-ethoxy-disubstituted oxanilides.

2.8 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)4′,6-bis(2′,4-dimethylphenyl)-1,3,5-triazine, 2-(2,4-dihydroxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine.

3. Metal deactivators, for example, N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, bisisodecyloxy pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocin, 6-fluoro-2,4,8,10-tetra-tert-butyl-12-methyl-dibenzo[d,g]-1,3,2-dioxaphosphocin, bis(2,4-di-tert-butyl-6-methylphenyl) methyl phosphite, bis(2,4-di-tert-butyl-6-methylphenyl) ethyl phosphite, tris(2-tert-butyl-4-thio(2′-methyl-4′-hydroxy-5′-tert-butyl)phenyl-5-methyl) phenyl phosphite, 2,2′,2″-nitrilo[triethyl tris(3,3′,5,5′-tetra-tert-butyl-1,1′-biphenyl-2,2′-diyl) phosphite], bis[2-methyl-4,6-bis(1,1-dimethylethyl)phenol]phosphorous acid ethyl ester.

5. Hydroxylamines, examples being N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecyl-hydroxylamine, N,N-dialkylhydroxylamines prepared from hydrogenated tallow fatty amine.

6. Nitrones, examples being N-benzyl alpha-phenyl nitrone, N-ethyl alpha-methyl nitrone, N-octyl alpha-heptyl nitrone, N-lauryl alpha-undecyl nitrone, N-tetradecyl alpha-tridecyl nitrone, N-hexadecyl alpha-pentadecyl nitrone, N-octadecyl alpha-heptadecyl nitrone, N-hexadecyl alpha-heptadecyl nitrone, N-octadecyl alpha-pentadecyl nitrone, N-heptadecyl alpha-heptadecyl nitrone, N-octadecyl alpha-hexadecyl nitrone, nitrones derived from N,N-dialkylhydroxylamines prepared from hydrogenated tallow fatty amines.

7. Zeolites and hydrotalcites, such as ®DHT 4A. Hydrotalcites of this kind can be described by the formula

[(M²⁺)₁₋ₓ(M³⁺)ₓ(OH)₂(Aⁿ⁻)_{x/n} yH₂O],

where

(M²⁺) is Mg, Ca, Sr, Ba, Zn, Pb, Sn, Ni

(M³⁺) is Al, B, Bi

Aⁿ is an anion of valency n

n is an integer from 1-4

x is a value between 0 and 0.5

y is a value between 0 and 2

A is OH⁻, Cl⁻, Br⁻, I⁻, ClO₄—, CH₃COO⁻, C₆H₅COO⁻, CO₃²⁻, SO₄²⁻, (OOC—COO)²⁻, (CHOHCOO)₂²⁻, (CHOH)₄CH₂OHCOO⁻, C₂H₄(COO)₂²⁻, (CH₂COO)₂²⁻, CH₃CHOHCOO⁻, SiO₃²⁻, SiO₄⁴⁻, Fe(CN)₆³⁻, Fe(CN)₆⁴⁻, BO₃³⁻, PO₃³⁻, HPO₂²⁻.

Preference is given to employing hydrotalcites in which (M²⁺) is (Ca2+), (Mg²⁺) or a mixture of (Mg²⁺) and (Zn²⁺); (Aⁿ⁻) is CO₃²⁻, BO₃³⁻, PO₃³⁻; x has a value from 0 to 0.5 and y has a value from 0 to 2. It is also possible to employ hydrotalcites that can be described with the formula

[(M²⁺)ₓ(Al³⁺)₂(OH)_{2k+6nz} (Aⁿ⁻)₂yH₂O].

Here, (M²⁺) is Mg²⁺, Zn²⁺, but more preferably Mg²⁺. (A n) is an anion, in particular from the group consisting of CO₃²⁻, (OOC—COO)²⁻, OH and S²⁻, where n describes the valency of the ion. y is a positive number, more preferably between 0 and 5, especially between 0.5 and 5. x and z have positive values, which in the case of x are preferably between 2 and 6 and in the case of z should be less than 2. The hydrotalcites of the following formulae are to be regarded with particular preference:

Al₂O₃×6MgO×CO₂×12H₂O,

Mg_{4.5}Al₂(OH)₁₃×CO₃×3.5H₂O,

4MgO×Al₂O₃×CO₂×9H₂O,

4MgO×Al₂O₃×CO₂×6H₂O,

ZnO×3MgO×Al₂O₃×CO₂×8-9H₂O,

ZnO×3MgO×Al₂O₃×CO₂×5-6H₂O,

Mg_{4.5}Al₂(OH)₁₃×CO₃.

Hydrotalcites are employed in the polymer preferably in a concentration of from 0.01 to 5% by weight, in particular from 0.2 to 3% by weight, based on the overall polymer formulation.

8. Thiosynergists, examples being dilauryl thiodipropionate and distearyl thiodipropionate.

9. Peroxide scavengers, examples being esters of β-thiodipropionic acid, for example the lauryl, stearyl, myristyl or tridecyl ester, mecaptobenzimidazole, the zinc salt of 2-mercaptobenzimidazole, zinc alkyldithiocarbamates, zinc dibutyidithiocarbamate, dioctadecyl monosulfide, dioctadecyl disulfide, pentaerythritol tetrakis(β-dodecylmercapto)propionate.

10. Polyamide stabilizers, examples being copper salts in combination with iodides and/or phosphorus compounds and salts of divalent manganese.

11. Basic costabilizers, examples being melamine, polyvinylpyrrolidone, dicyandiamide, triallyl cyanurate, urea derivatives, hydrazine derivatives, amines, polyamines, polyurethanes, alkali metal and alkaline earth metal salts of higher fatty acids, for example Ca stearate, Zn stearate, Mg behenate, Mg stearate, Na ricinoleate, K palmitate, antimony pyrocatecholate or tin pyrocatecholate, alkali metal and alkaline earth metal salts and also the zinc salt or the aluminum salt of lactic acid.

12. Nucleating agents, such as inorganic substances, examples being talc, metal oxides, such as titanium oxide or magnesium oxide, phosphates, carbonates or sulfates of, preferably, alkaline earth metals, organic compounds, such as mono- or polycarboxylic acids and also their salts, examples being 4-tert-butylbenzoic acid, adipic acid; diphenylacetic acid; sodium succinate or sodium benzoate; acetals of aromatic aldehydes and polyfunctional alcohols such as sorbitol, for example, such as 1,3-2,4-di(benzylidene)-D-sorbitol, 1,3-2,4-di(4-tolylidene)-D-sorbitol, 1,3-2,4-di(4-ethylbenzylidene)-D-sorbitol, polymeric compounds, such as ionic copolymers (ionomers), for example.

13. Fillers and reinforcing agents, examples being calcium carbonate, silicates, glass fibers, asbestos, talc, kaolin, mica, barium sulfate, metal oxides and metal hydroxides, carbon black, graphite, wood flour and other flours or fibers of other natural products, synthetic fibers.

14. Other additives, examples being plasticizers, lubricants, emulsifiers, pigments, rheological additives, catalysts, leveling assistants, optical brighteners, flame-proofing agents, antistatics, blowing agents.

15. Benzofuranones and indolines, as described for example in U.S. Pat. No. 4,325,863, U.S. Pat. No. 4,338,244, U.S. Pat. No. 5,175,312; U.S. Pat. No. 5,216,052; U.S. Pat. No. 5,252,643, DE-A-4316611, DE-A-4316622, DE-A-4316876, EP-A-0589839 or EP-A-0591102, or 3-[4-(2-acetoxy-ethoxy)phenyl]-5,7-di-tert-butylbenzofuran-2-one, 5,7-di-tert-butyl-3-[4-(2-stearoyloxyethoxy)phenyl]-benzofuranon-2-one, 3,3′-bis[5,7-di-tert-butyl-3-(4-[2-hydroxyethoxy]phenyl)-benzofuran-2-one, 5,7-di-tert-butyl-3-(4-ethoxyphenyl)-benzofuran-2-one, 3-(4-acetoxy-3,5-dimethylphenyl)-5,7-di-tert-butylbenzofuran-2-one, 3-(3,5-diethyl-4-pivaloyloxyphenyl)-5,7-di-tert-butylbenzofuran-2-one.

An obvious advantage of the new systems is the technical availability of polyamide-based articles, which contain chemically fixed UV-absorbers having suppressed tendency of migration. This fact is important especially for long-term uses of those articles. Surprisingly these new systems exhibit improved mechanical properties in comparison with conventional polyamides where UV-absorbers are physically mixed with the substrate.

As mentioned above the manufacture of polyamide copolymers leads in general to products with enhanced solubility but less favorable mechanical properties. Surprisingly, in the given case co-polycondensation improves those properties in general significantly.

The following examples shall demonstrate the invention in a non limiting way.

### EXAMPLES

### Synthesis of Co-Polyamides

The synthesis of polyamide and the mentioned co-polyamides containing UV-absorbers took place in a stainless steel autoclave (volume: 5 l) connected with a heating cycle and combined with an electrical heatable bottom blow valve. An intense mixing within the reactor was guaranteed by a stainless steel stirring device with adjustable speed. The pressure inside the autoclave was controllable by means of a manometer and manually adjustable using a pressure regulating valve. A bursting disc was used as pressure-releasing valve. Purification of the autoclave took place by heating with triethyleneglycol at a temperature of 250° C., with methanol at a temperature of 64° C. and ethylacetate at T=77° C., afterwards manually with small amounts of acetic acid.

All batches manufacturing the homopolymer were carried out starting with 700 g (6.19 mol) caprolactame (melting point T=69° C., boiling point T=268° C.). After heating in the autoclave a permanent nitrogen-stream was blown through the apparatus under regular stirring which was continued 30 minutes after a complete melting of capro-lactame in order to remove free oxygen quantitatively out of the reactor, the temperature of the melt was kept at T=80° C. About 75 minutes after the first melting the following chemicals have been added: 7.0 g (1% by weight, 0,55 mol-%) ε-amino-capronic acid, 2.1 g (0.3% by weight, 17 mmol, 0,28 mol-%) benzoic acid and 21,0 ml (3,0% by weight, 1.17 mmol, 18,8 mol-%) bidestilled water. Afterwards the autoclave was completely sealed. The heating of the reaction mixture took place initially during 2 hours at T=230° C. before a slow heating within further 2 hours up to T=245° C. was chosen keeping this temperature for one further hour. The pressure inside the autoclave raised up to 4-4,5 bar. About 5 hours after starting the excess pressure phase a careful pressure release during 35-40 min took place. A fast pressure release must be strictly avoided otherwise the reaction mixture foams up plugging the pressure regulating valve. The stream of overheated water steam and nitrogen was conducted using a PVC-tube into cold water. After reaching normal pressure the reaction mixture was heated under nitrogen up to T=260° C. After further 2-3 hours the reaction was interrupted. The product was removed via the bottom valve onto ice using a nitrogen excess pressure of about four bars. Using a winding drum the escaping polymer hank was collected an afterwards granulated.

Yield: 75-85% by weight referring to the initial amount of caprolactame.

For co-polycondensation with UV-absorbers of the mentioned type, 0.5% by weight of these compounds related to the initial amount of caprolactame was inserted into the reactor at the beginning. The following procedure was the same as described above.

### Manufacture of Polyamide-Fibers

The manufacture of fibers took place using a single screw extruder with a superposed dryer. The five heating zones of the extruder were set in a temperature interval between 289° C. (zone 1) and 265° C. (spin head). The spinneret consisted of 400 nozzles (diameter 10 μm). The screw was driven with 40 rpm yielding a capacity of 0.6 dm³/min. At the spinneret, the melt reached a pressure of up to 30 bar. For purposes as spin finishing an aqueous solution Dryfi RIL in a concentration of 6% by weight was used which was applied at the winder as part of the POY (Pre-Oriented Yarn) filament line. The winder itself was used with a speed of 4000 rpm.

A series of test parameters out of a mechanical test program is shown in table 1. The data elucidate the surprisingly found advantage using stabilizers like the two UV-absorbers Sanduvor® PR-25 and Sanduvor® VSU in a co-polycondensated form in polyamide.

TABLE 1
Influence of mixed and co-polycondensated UV-absorbers on mechanical
properties of polyamide-6-fibers

| | | comparative | | PA-6 co-poly- | |
|---|---|---|---|---|---|
| | | mixture PA-6 | comparative | condensated ex | PA-6 co-poly- |
| | | caprolactame | mixture PA-6 | caprolactame | condensated ex |
| | comparative | with 0.5% | with 0.5% | with 0.5% | caprolactame |
| | experimental | Sanduvor ® | Sanduvor ® | Sanduvor ® PR- | with 0.5% |
| | PA-6 (ICF) | PR-25 | VSU | 25 | Sanduvor ® VSU |
| elongation at | 47 | 53 | 53 | 63 | 69 |
| break (%) | | | | | |
| tenacity | 27.6 | 39.4 | 37.2 | 42.8 | 46.1 |
| (cN/tex) | | | | | |
| count (dtex) | 24.5 | 24.8 | 25 | 26.1 | 32.2 |
| modulus | 85.9 | 105.4 | 85.2 | 171.2 | 152.6 |
| (cN/tex) | | | | | |

1. Polyamide containing chemically bound UV-absorbers of the type oxanilide or benzylidene-malonate produced by co-condensation of the UV-absorbers with the prepolymeric compounds.

2. Polyamide as claimed in claim 1 wherein the UV-absorbers are 2-ethyl-2′-ethoxy-oxanilide or propanedioic acid-[(4-methoxyphenyl)-methylene]-dimethylester.

3. Polyamide as claimed in claim 1 or 2 wherein the prepolymeric compounds are caprolactame, ε-amino-capronic acid and benzoic acid.

4. Process for the production of polyamides with improved mechanical properties as claimed in any of claims 1 to 3 wherein the prepolymeric compounds and the UV-absorbers are mixed prior to the condensation reaction and wherein the UV-absorbers are used in a concentration range of from 0.0001 to 5% by weight, related to the prepolymeric compounds.

5. Process as claimed in claim 4 wherein the concentration of the UV-absorbers is from 0.001 to 3% by weight, related to the prepolymeric compounds.

6. A method of use of polyamides as claimed in any of claims 1 to 3 for the manufacture of fibres having improved mechanical properties.
